(19) United States
(12) Patent Application Publication
(10) Pub. No.: US 2015/0313172 A1
(43) Pub. Date: Nov. 5, 2015

(54) SYSTEM AND METHOD FOR MONITORING FARM RELATED EQUIPMENT

(71) Applicants: Robin JOHNSTON, Arnprior (CA); Kory L. MCANDREW, Ottawa (CA)

(72) Inventors: Robin Alexander JOHNSTON, Arnprior (CA); Kory L. MCANDREW, Ottawa (CA)

(21) Appl. No.: 14/646,432

(22) PCT Filed: Nov. 21, 2013
(86) PCT No.: PCT/CA2013/050888

§ 371 Date: May 21, 2015

Related U.S. Application Data
(60) Provisional application No. 61/729,448, filed on Nov. 23, 2012.

(51) Int. Cl. A01J 5/007; A01J 5/04

(52) U.S. Cl. CPC A01J 5/007; A01J 5/04

(57) ABSTRACT

Systems and methods for continuous monitoring of farm-related equipment. Multiple sensors are deployed such that the pressure resulting from each pulsator is monitored. Sensor data is transmitted from the sensors to a data collection and forwarding subsystem. The subsystem then forwards the sensor data to a server. The server analyzes the sensor data and determines if the farm-related equipment is operating within acceptable parameters. Should the equipment be underperforming based on predetermined standards, an alarm is communicated to one or more users. The alarm can be received by way of an email, a text message, or any other known ways of communications.

### TECHNICAL FIELD

The present invention relates to monitoring systems. More specifically, the present invention relates to methods and systems for monitoring farm-related equipment, specifically equipment related to the milking of cows.

### BACKGROUND OF THE INVENTION

The early 21st century has shown increasing advances in technology. Such advances in technology have also filtered into farm and farming-related equipment. With farmer and farming-related occupations declining as a percentage of the population with populations increasing, technology has stepped in to fill the numbers gap. Instead of large numbers of farmers, technology multiplies the effect of each farmer as machines perform the work of multiple farmers.

In terms of milk production, current technology uses machines to simultaneously milk multiple cows. The udder of a cow is attached to a milking claw that has multiple liners that separate a pulsator side and a milking side of a tube with a liner. The milking side is the internal portion of the liner where the cow's teat is positioned. The pulsator side is the section between the internal portion of the tube and the external portion of the liner.

The milking system is divided into the milking side and the pulsator side. When the milking system is active, a vacuum is created in both the pulsator and the milking sides by a vacuum pump that removes air from the system. When a teat is not attached to the milking system, the vacuum (i.e. the pressure) created will be the same on both the milking side and the pulsator side of the system. When the cows are attached to the milking system by the milking claws, milk and vacuum are present on the milking side. This will cause the pressure on the milking side of the system to be lower than the pressure on the pulsator side.

A pulsator (a device that sits on top of the pulsator lines on the pulsator side of the system) alternately exposes the area between the liner and the tube to air and vacuum. When exposed to vacuum, the liner is pulled open around the teat and milk flows. Milk flows because the teat is exposed to vacuum. When exposed to air, the liner collapses around the teat, and the teat is not exposed to the vacuum on the milking side of the system, thereby causing the milk flow to stop and the teat rests. This pulsator action generally takes place around between 45 and 65 times a minute.

Unfortunately, failure of these pulsators or their functioning at less than acceptable/optimal capacity can cause major issues. Abrupt reduction of the vacuum on the milking side can cause movement of air towards the teat end, and droplets of milk may strike the teat end. If the droplets have bacteria, the impact may force the bacteria into the teat ducts. The milk or the water droplets can be a carrier of mastitis pathogens from one cow to the next. Pathogens and bacteria such as streptococcus agalactiae, staphylococcus aureus, and mycoplasma maybe transferred from one cow to the next. Such bacteria and pathogens can be transferred during milking from an infected quarter across a multiple tube system to an uninfected quarter through the above described mechanism.

Currently, pulsators and the milking apparatus connected to the pulsators are only checked sporadically, if at all, for correct functioning. Such checking may not catch sub-optimal operating conditions in the system which may lead to increased chances of infection to the livestock.

There is therefore a need for systems and methods which mitigate if not overcome the limitations of the prior art.

### SUMMARY OF INVENTION

The present invention provides systems and methods for continuous monitoring of farm-related equipment. Multiple sensors are deployed such that the pressure resulting from each pulsator is monitored. Sensor data is transmitted from the sensors to a data collection and forwarding subsystem. The subsystem then forwards the sensor data to a server. The server analyzes the sensor data and determines if the farm-related equipment is operating within acceptable parameters. Should the equipment be underperforming based on predetermined standards, an alarm is communicated to one or more users. The alarm can be received by way of an email, a text message, or any other known ways of communications and is displayed on a user interface.

In a first aspect, the present invention provides a system for monitoring equipment for use in milking cows, the system comprising:
at least one sensor for sensing characteristics of said equipment and generating sensor data based on said characteristics;
a server for receiving sensor data from said at least one sensor and for determining if said sensor data indicates an alarm condition;
a data collection and forwarding subsystem for receiving sensor data from said at least one sensor and forwarding said sensor data to said server; and
a communication module for sending alerts to users when said sensor data indicates an alarm condition, said communication module being in communication with said server.

In a second aspect, the present invention provides a method for ensuring continuing functioning of farm-related equipment, the method comprising:
a) providing at least one sensor for sensing characteristics of said equipment and generating sensor data based on said characteristics;
b) providing a server for receiving sensor data from said at least one sensor and for determining if said sensor data indicates an alarm condition;
c) providing a data collection and forwarding subsystem for receiving sensor data from said at least one sensor and forwarding said sensor data to said server;
d) providing a communication module for sending alerts to users when said sensor data indicates an alarm condition, said communication module being in communication with said server;
e) sensing at least one characteristic of said equipment using said at least one sensor;
f) receiving sensor data from said at least one sensor using said subsystem;
g) forwarding said sensor data to said server from said subsystem;
h) receiving said sensor data at said server;
i) analyzing said sensor data using said server;
j) determining if said sensor data indicates an alarm condition based on an analysis of said sensor data;
k) in the event an alarm condition is present, sending at least one alert to at least one user using said communication module.

In a further aspect, the present invention provides computer-readable media having encoded thereon computer-readable instructions which, when executed, implements a method for ensuring continuing functioning of farm-related equipment, the method comprising:
a) providing at least one sensor for sensing characteristics of said equipment and generating sensor data based on said characteristics;
b) providing a server for receiving sensor data from said at least one sensor and for determining if said sensor data indicates an alarm condition;
c) providing a data collection and forwarding subsystem for receiving sensor data from said at least one sensor and forwarding said sensor data to said server;
d) providing a communication module for sending alerts to users when said sensor data indicates an alarm condition, said communication module being in communication with said server;
e) sensing at least one characteristic of said equipment using said at least one sensor;
f) receiving sensor data from said at least one sensor using said subsystem;
g) forwarding said sensor data to said server from said subsystem;
h) receiving said sensor data at said server;
i) analyzing said sensor data using said server;
j) determining if said sensor data indicates an alarm condition based on an analysis of said sensor data;
k) in the event an alarm condition is present, sending at least one alert to at least one user using said communication module.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention; and

FIG. 2 is a flowchart of a method according to another aspect of the invention.

### DETAILED DESCRIPTION OF THE INVENTION

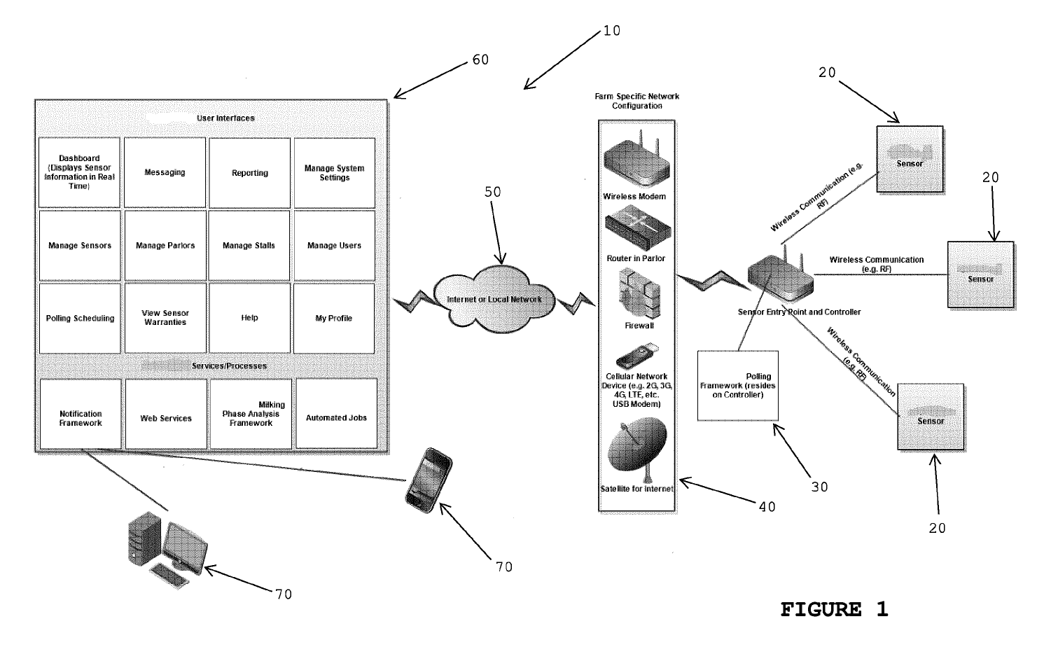

Referring to FIG. 1, a block diagram of a system according to one aspect of the invention is illustrated. The system 10 has sensors 20, a sensor controller 30, and a communications subnetwork 40. Communicating with the subnetwork 40 by way of network 50 is a server 60. The server 60 communicates with computing and/or communications device 70. It should be noted that the sensor controller 30 also operates as a sensor entry point and that, a polling framework (i.e. software for polling the sensors) forms part of the sensor controller 30.

In operation, the sensors 20 sense the characteristics of the farm-related or farming equipment. Such equipment can be cow milking equipment including pulsators and other related equipment. The characteristics of the equipment sensed can include the pressure generated due to the action of the pulsator, the timing of the pulsators, the volume of milk extracted, the temperature of the milk extracted, the temperature of the pulsators and its surrounding areas, the pressure generated by the vacuum pumps used, the temperature of wash water as well as other operating parameters that can be determined using different types of sensors. As well, other characteristics of other farm related or farming equipment may be monitored. Such characteristics may include the temperature, condition, and/or pressure of any vessel, pipe, or container which may be used for storing, conveying, or passing solid, liquid, or gas. It should be noted that, when referring to temperature of liquids such as the milk extracted or the wash water, the temperature measured may refer to the temperature of the liquid itself or to the temperature of the container used to store the liquid.

In one implementation, the sensors may be transducers and these transducers may be used for monitoring pressure. In such an implementation, the pressure at a point downstream from a pulsator can be automatically sensed and continuously monitored. The use of such a sensor or a similar sensor allows for an on-demand function (which can also be automated) that will read n pressure readings in m seconds at 1 reading per millisecond, 1 or more times. Of course, n>0, m>0 and m can have decimal values. The system, using the server 60, determines the number of milliseconds in each milking phase, i.e. every m seconds the pulsations will be categorized in one of 4 phases (A, B, C, D, where A+B is the milking phase and C+D is the rest phase). The results can then be sent to one or more users in lieu of or in addition to potential alarm notifications.

The sensor data from the sensors are passed from the sensors 20 to the sensor controller 30. In FIG. 1, the sensor controller is illustrated as a wireless mesh network appliance that is capable of directly communicating with the various sensors. The network appliance then passes on the sensor data to the subnetwork 40 which may include routers, modems, and switches. The subnetwork 40 and the sensor controller 30 are part of a data collection and forwarding subsystem whose function is to receive sensor data from the sensors and to forward such sensor data to the server 60. It should be clear that the sensors are in communication with the data collection and forwarding subsystem. This communication can be accomplished by wired links linking the sensors to the network appliance or, more preferably, by way of wireless links between the sensors and the network appliance. The use of wireless links can greatly simplify implementation of the system.

Once the sensor data has been received by the data collection and forwarding subsystem, the sensor data is then transmitted to the server 60 by way of the network 50. The network 50 may be a local network, part of a local network, or may include an extended network such as the Internet or a wide area network.

The server 60 receives the sensor data from the data collection and forwarding subsystem. This sensor data is analyzed by the server 60 and a determination is made as to whether the sensor data indicates that the equipment is operating within acceptable parameters. It should be noted that the analysis may include comparing at least part of the sensor data with predetermined acceptable ranges stored on the server. The predetermined acceptable ranges may include upper limit ranges as well as lower limit ranges for the sensed characteristics of equipment. Sensor data that does not comply with the predetermined acceptable ranges may indicate a malfunction or a potential malfunction in the equipment.

The analysis performed by the server 60 on the sensor data may be as simple as a comparison between specific portions of the sensor data and predetermined acceptable limits on the sensor data. As an example, maximum values that should not be exceeded or minimum values may be used. Alternatively, the analysis may take the form of a historical analysis of the equipment—a degrading performance, over time, of the equipment may mean that the equipment may need replacement before catastrophic failure. Similarly, the analysis may involve an in-depth, multi-variable analysis that determines if the equipment, as a whole, is functioning properly. As can be imagined, the different sensors may be positioned at different parts of the farming or farming-related equipment to gather different types of data on different sections or portions of the equipment.

If the server 60 determines that the sensor readings indicate an alarm condition, i.e. that the conditions at the equipment show that a potential failure, issue, or undesirable condition is about to occur or is in the midst of occurring, the server 60 can send out a communication to a user who needs to be notified of the problem. The communication to the user can be by way of an email alert to the user's email account, a text message (SMS) to the user's mobile handset, an automated voice telephone call to the user, or any other automated communication means. In addition to the above, the alarm can also be displayed on a user interface on the server or on a computing device connected to the server. Ideally, the user receives the alert and can deal with the potential emergency. In one implementation, the user can login to the server using a web browser interface and view the conditions or sensor readings that caused the alarm. For this functionality, the server 60 has a communication module which handles the incoming and outgoing communications to not just the subsystem but also to the users.

Regarding the server 60, as can be seen from FIG. 1, the server 60 can have a number of components which may be useful in dealing with the potential emergency or with determining the urgency of the situation. The server 60 in FIG. 1 has a web access interface that can be accessed by users by way of the Internet using a web browser. Through the browser, the user can view the sensor data (i.e. the user can view the sensor data to determine if the issue is with the sensors and not the equipment being monitored), manage the sensors (i.e. add or subtract sensors), change the parameters for the system (e.g. frequency of notification, frequency of sensor data updates, user access settings), view and create reports (e.g. statistical reports about data collected, information about the current state of the sensors), send and receive messages to/from other users in the system, as well managing the different farm locations and/or milking parlors being monitored. Of course, for this functionality, the server 60 is coupled or is in communication with the various locations being monitored along with the sensors in the system. For ease of use, the server 60 can also be configured to provide real-time sensor data to a user logged in. Alternatively, instead of sensor data, the server 60 can show a logged in user the latest sensor data available.

It should be noted that while the above discussion refers to a web-browser accessible server 60 and to accessing the various services available by way of a web-browser, other options may be possible depending on the implementation. While a web browser interface might be most convenient as any network connected device with a web browser may be used, apps or applications developed specifically for small form factor computing devices (e.g. tablets and smartphones) may also be used. As an example, an app developed specifically for devices running the Android™ operating system or the iOS™ operating system or other similar operating systems may be used. Such apps would, ideally, access the server and its available services directly. It should be clear that any computing device capable of operating a web browser application or capable of logging in to a server may be used with the invention.

The server 60 can have multiple modules which can be used for different purposes. As can be seen from FIG. 1, the server 60 may have modules for managing locations (parlors), messaging, managing system users, managing system settings, managing the various sensors at the various locations, managing reporting of alarms and data to the various users, managing stalls, adjusting a polling schedule, viewing sensor warranties, managing a user's profile, a help module, and a module for a dashboard to display sensor information in real-time. Other modules which may be a combined hardware/software modules, may relate to user notifications, the system's web enabled and web accessible services, as well as the system's analysis functions. Of course, the system's analysis functions will depend on the implementation and the desired complexity and usefulness of the analysis performed on the sensor data received by the server.

The systems operates as described below. As noted above, the server 60 has a web interface through which a user may access the various functions and modules available. Also as noted above, the sensor controller 30 includes the polling framework. In operation, the system 10 operates with the server 60 on standby as it waits for requests for data or for data to be sent to it. The polling framework requests and retrieves configuration data and sensor identification from the server every t1 milliseconds. The sensor identification identifies which sensors to poll and the configuration data is data that defines the configuration for the sensors to be polled. From the sensor identification data, the polling framework then operates through the sensor controller to poll or retrieve sensor data from the relevant sensors. Once the sensors have been polled by the sensor controller, the polling framework returns sensor readings to the server 60 every t2 milliseconds. Once the server 60 has received the sensor data from the polling framework, the sensor data is analyzed and a determination is made as to whether the data indicates that there is a problem. If the data is as expected and there is no problem, the system returns to its standby mode and waits for data requests and data transmissions. If, on the other hand, the data is not what is expected, then the server generates an alarm. The alarm is displayed on the system's web based user interface and the alarm also generates alarm communications that are sent to a user's mobile handset (e.g. by way of a text or SMS message), a user's email, or by using any other communications means for which the system is configured. Once the alarm communication has been sent and the alarm has been displayed on the user interface, the server 60 returns to its standby mode and waits for data requests or for data to be sent to it.

As an alternative to the above, the system may use different modes of operation for data received and sent to the sensors. As a feature of the system, the sensor data can be sent to the server 60 periodically by the data and communication subsystem without any prompting from the server. This “push” model would have the data collection and communication subsystem receiving sensor data from the sensors and then forwarding the sensor data to the server 60. Alternatively, a “pull” model can be used where the server 60 only receives sensor data from the data collection and communication subsystem after the server requests the sensor data. In this alternative, the server “pulls” sensor data from the subsystem by asking or requesting the latest sensor data. In one implementation, the data collection and communication subsystem caches or temporarily stores the latest sensor data until the server issues a request for the sensor data. If new sensor data arrives at the data collection and communication subsystem before the previous sensor data is requested, the older sensor data may be stored for later retrieval or overwritten by the new sensor data. The caching of old data is, of course, not required.

It should be noted that the server 60 may be used to monitor multiple locations (e.g. other milking parlors) with each location having multiple instances of equipment being monitored. For such a server, each location may be configured differently with different users needing to be contacted for a potential emergency for each location and with different parameters and characteristics being monitored for each location, perhaps with the use of different types of sensors. The server may be located on the premises of a location being monitored such that only a local network is used for communications within the system. Alternatively, the server is located remotely from any of the location or locations being monitored with communications being transmitted between the server and the locations by way of the Internet.

In an implementation where the server is located remotely from the location being monitored, it should be noted that the server may be multiple servers and not a single, stand-alone server. A suitably configured cloud computing-based application may be used to provide the functionality of the server described above.

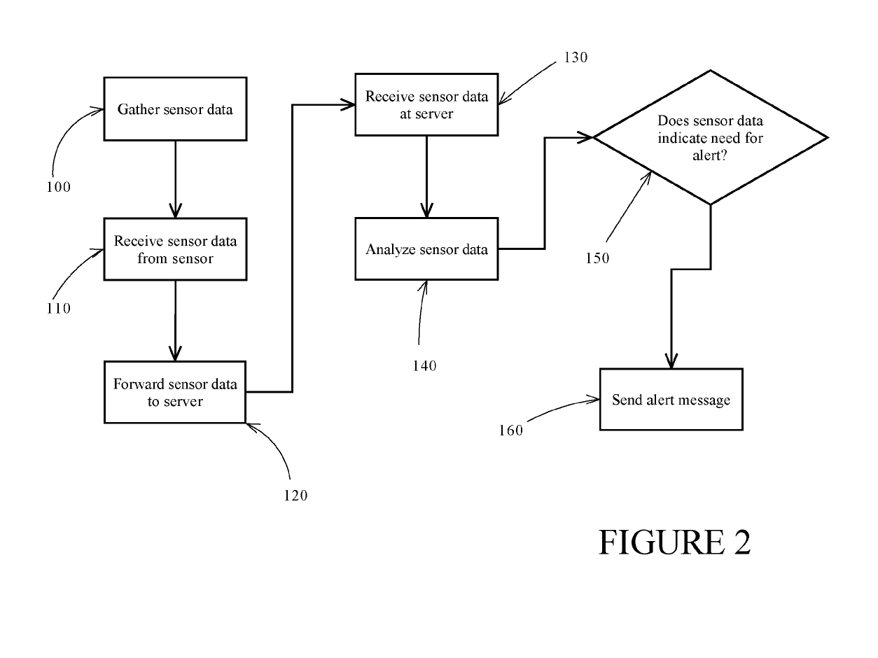

Referring to FIG. 2, a flowchart of a method according to another aspect of the invention is illustrated. The method begins at step 100, that of gathering sensor data by sensing at least one characteristic of the farm or farm-related equipment. Step 110 is that of receiving the sensor data from the sensor. This step can be performed by the data collection and communications subsystem described above. Once received, the sensor data is then forwarded to the server for analysis (step 120). The sensor data is then received at the server (step 130). The server then analyzes the sensor data at step 140. A decision 150 then determines if an alarm condition exists at the equipment. If necessary, an alarm is communicated to at least one user (step 160). If an alarm condition does not exist, the logic flow returns to step 100, that of gathering sensor data.

It should be noted that the method illustrated in FIG. 2 can be used with any of the multiple configurations described above. The method can be used for the configuration where the polling framework automatically retrieves configuration and sensor identification data and automatically sends sensor data to the server. As well, the method can be used for either the “pull” or the “push” configuration of the system. In the “pull” configuration, the server requests the server data prior to step 130. In the absence of such a request, step 130 and the rest of the method is ignored. The rest of the steps are only executed after the request has been made.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”, “Java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for monitoring equipment for use in milking cows, the system comprising:
at least one sensor for sensing characteristics of said equipment and generating sensor data based on said characteristics;
a server for receiving sensor data from said at least one sensor and for determining if said sensor data indicates an alarm condition;
a data collection and forwarding subsystem for receiving sensor data from said at least one sensor and forwarding said sensor data to said server; and
a communication module for sending alerts to users when said sensor data indicates an alarm condition, said communication module being in communication with said server.

2. A system according to claim 1 wherein said equipment comprises equipment for milking cows.

3. A system according to claim 2 wherein said equipment comprises at least one pulsator.

4. A system according to claim 3 wherein said characteristics of said equipment comprises a vacuum pressure generated by said pulsator.

5. A system according to claim 1 wherein said server compares sensor data with predetermined values to determine if said characteristics of said equipment are within acceptable limits.

6. A method for ensuring continuing functioning of farm-related equipment, the method comprising:
a) providing at least one sensor for sensing characteristics of said equipment and generating sensor data based on said characteristics;
b) providing a server for receiving sensor data from said at least one sensor and for determining if said sensor data indicates an alarm condition;
c) providing a data collection and forwarding subsystem for receiving sensor data from said at least one sensor and forwarding said sensor data to said server;
d) providing a communication module for sending alerts to users when said sensor data indicates an alarm condition, said communication module being in communication with said server;
e) sensing at least one characteristic of said equipment using said at least one sensor;
f) receiving sensor data from said at least one sensor using said subsystem;
g) forwarding said sensor data to said server from said subsystem;
h) receiving said sensor data at said server;
i) analyzing said sensor data using said server;
j) determining if said sensor data indicates an alarm condition based on an analysis of said sensor data;
k) in the event an alarm condition is present, sending at least one alert to at least one user using said communication module.

7. A method according to claim 6 wherein step g) is automatically executed without requiring input from said server.

8. A method according to claim 6 wherein said subsystem sends sensor data to said server absent any request from said server for said sensor data.

9. A method according to claim 6 wherein step i) comprises comparing values in said sensor data with predetermined values stored in said server.

10. A method according to claim 9 wherein said predetermined values comprise maximum acceptable values for said sensor data.

11. A method according to claim 9 wherein said predetermined values comprise minimum acceptable values for said sensor data.

12. A method according to claim 6 wherein said equipment comprises equipment for milking cows.

13. A method according to claim 12 wherein said equipment for milking cows comprises at least one pulsator.

14. A method according to claim 6 wherein step g) is automatically executed without requiring input from said server.

15. A method according to claim 6 wherein said characteristics is at least one of:
a pressure generated due to an action of a pulsator,
a timing of at least one pulsator,
a volume of milk extracted,
a temperature of milk extracted,
a temperature of said at least one pulsator,
a temperature of an area surrounding said at least one pulsator,
a pressure generated by vacuum pumps
a temperature of wash water,
a pressure of a pipe used for conveying liquid or gas, and
a temperature of a pipe used for conveying liquid or gas.

16. Computer-readable media having encoded thereon computer-readable instructions which, when executed, implements a method for ensuring continuing functioning of farm-related equipment, the method comprising:
a) providing at least one sensor for sensing characteristics of said equipment and generating sensor data based on said characteristics;
b) providing a server for receiving sensor data from said at least one sensor and for determining if said sensor data indicates an alarm condition;
c) providing a data collection and forwarding subsystem for receiving sensor data from said at least one sensor and forwarding said sensor data to said server;
d) providing a communication module for sending alerts to users when said sensor data indicates an alarm condition, said communication module being in communication with said server;
e) sensing at least one characteristic of said equipment using said at least one sensor;
f) receiving sensor data from said at least one sensor using said subsystem;
g) forwarding said sensor data to said server from said subsystem;
h) receiving said sensor data at said server;
i) analyzing said sensor data using said server;
j) determining if said sensor data indicates an alarm condition based on an analysis of said sensor data;
k) in the event an alarm condition is present, sending at least one alert to at least one user using said communication module.

17. Computer-readable media according to claim 15 wherein said characteristics is at least one of:
a pressure generated due to an action of a pulsator,
a timing of at least one pulsator,
a volume of milk extracted,
a temperature of milk extracted,
a temperature of said at least one pulsator,
a temperature of an area surrounding said at least one pulsator,
a pressure generated by vacuum pumps,
a temperature of wash water,
a pressure of a pipe used for conveying liquid or gas, and
a temperature of a pipe used for conveying liquid or gas.

18. A system according to claim 1 wherein said characteristics is at least one of:
a pressure generated due to an action of a pulsator,
a timing of at least one pulsator,
a volume of milk extracted,
a temperature of milk extracted,
a temperature of said at least one pulsator,
a temperature of an area surrounding said at least one pulsator,
a pressure generated by vacuum pumps,
a temperature of wash water,
a pressure of a pipe used for conveying liquid or gas, and
a temperature of a pipe used for conveying liquid or gas.
